(19) United States
(12) Patent Application Publication
(10) Pub. No.: US 2007/0083309 A1
(43) Pub. Date: Apr. 12, 2007

(54) Method for controlling the longitudinal movement of a motor vehicle

(75) Inventors: Bernd Danner, Achalmstrasse (DE); Ingo Dudeck, SchieBackerweg (DE); Helmut Eisele, Brombergstrasse (DE); Wolfgang Lauer, Solothurner Strasse (DE); Uwe Regensburger, Ostfildern (DE)

Correspondence Address: FITCH, EVEN, TABIN & FLANNERY, P. O. BOX 18415, WASHINGTON, DC, 20036, US

(73) Assignee: DaimlerChrysler AG, Stuttgart (DE)

(21) Appl. No.: 10/578,513

(22) PCT Filed: Sep. 11, 2004
(86) PCT No.: PCT/EP04/12651

§ 371 Date: Aug. 9, 2006

(30) Foreign Application Priority Data
Nov. 19, 2003 (DE) 103 54 073.3

(51) Int. Cl. B62D 6/00

(52) U.S. Cl. 701/41

(57) ABSTRACT

In a method for controlling the longitudinal movement of a vehicle (3), in particular by means of a longitudinal movement control system, wherein, for vehicle speeds above a threshold speed, the vehicle speed is adjusted to a higher selected set speed if no vehicle (8) traveling in front is detected, and if a vehicle (8) traveling in front is detected the distance from this vehicle (8) traveling in front is adjusted, below the threshold speed the longitudinal movement of the vehicle (3) is controlled only if a vehicle (8) traveling in front is detected. As a result, an inter-vehicle distance control system can be implemented over a relatively large speed range.

The invention relates to a method for controlling the longitudinal movement of a vehicle, in particular by means of a longitudinal movement control system, wherein, for vehicle speeds above a threshold speed, the vehicle speed is adjusted to a higher selected set speed if no vehicle traveling in front is detected, and if a vehicle traveling in front is detected the distance from this vehicle traveling in front is adjusted.

Such a method has been disclosed in DE 199 58 520 A1.

Inter-vehicle distance control systems (adaptive cruise control (ACC) systems) which are currently offered on the market operate only in a restricted speed range, for example in the range from 30 to 180 km/h. In known inter-vehicle distance control systems a speed is selected and the vehicle is adjusted to this speed if the distance from a vehicle traveling in front is large enough or if there is no vehicle traveling in front. If the distance from the vehicle traveling in front is shorter or if another vehicle cuts in in front of the vehicle to be controlled and the distance therefore becomes less than the safety distance, the inter-vehicle distance control system automatically brakes the vehicle until the safety distance from the vehicle now traveling in front is restored. This method of longitudinal movement control is referred to as free target selection. In this context, the ACC system decides automatically which detected object is relevant for the vehicle to be controlled and which objects are not relevant. This concept provides the driver with a very high level of comfort. This concept is particularly suitable at high speeds at which brief lateral movements of the vehicle to be controlled are not expected. For this reason, the ACC systems have a switch-on threshold of generally 30 km/h. For lower speeds the driver does not receive any support from the ACC system. Known ACC systems switch off automatically if the speed of the vehicle to be controlled drops below the switch-on threshold. In such a case, the ACC system audibly requests the driver to take over driving the vehicle.

For a newly sensed object a relevance for the driver's own driving function must be clarified. It is necessary to decide whether the object is of interest to the function of controlling the vehicle. In this context basically two types of relevant objects are differentiated: type 1 objects are objects on the adjacent lane which move at a lateral speed onto the lane of the vehicle to be controlled and are thus relevant for the vehicle to be controlled. Type 2 objects are stationary or moving objects in the area in front of the vehicle to be controlled, which objects lie on a collision course, depending on the route.

In the short-range area, there is often too little time between the detection of a new object and an adapted reaction (avoidance maneuver, braking) thereto owing to the typically short distance. It is therefore frequently not possible to decide in a reliable way whether a newly sensed object is relevant. For this reason, at present there is, inter alia, no support provided to the driver in the short-range area at low speeds.

Furthermore, the currently used beam sensors for sensing the vehicle traveling in front have only a small angle of aperture at a large distance. They therefore sense only a very narrow portion of the surroundings. In particular in the direct short-range area of the vehicle, it is not sufficient to observe the surroundings which are relevant to driving the vehicle. It is not possible, for example, to sense in good time vehicles which are cutting in.

DE 199 58 520 A1 discloses a speed controller which not only adjusts the speed of the vehicle starting from a specific minimum speed (v1) but also adjusts said speeds below a predefined limiting speed (v2) as far as the stationary state of the vehicle. With this speed controller it is possible even to adjust the speed range from the stationary state as far as the second limiting speed (v2) even at low speeds which occur very frequently in town traffic, by means of an additional “stop & go device”. This stop & go mode is effective below the second speed (v2) if the driver has not switched off the system and himself adjusts the distance from the vehicle traveling in front and his travel speed. If the vehicle is traveling in the speed range between v1 and v2, in particular if v1 is less than v2, the driver can select between the operating mode at relatively high speeds and the stop & go mode. However, he can also leave the decision to the speed controller itself. There is a sliding transition between the two states, the driver being able to determine the time of the state change himself since he is always informed about the current status. In the known speed controller there is therefore a need for action by the driver. Whenever interaction occurs with a human being it is not possible to rule out incorrect control.

The objective of the present invention is therefore to improve the driving comfort and the driving safety in vehicles with automatic speed setting.

The objective is achieved according to the invention by means of a method of the type mentioned at the beginning in which, below the threshold speed, the longitudinal movement of the vehicle is controlled only if a vehicle traveling in front is detected.

This method permits the driver to be supported during the longitudinal adjustment (maintaining distance from the person in front) even at low speeds, for example in the stop & go mode or in slow-moving traffic. In this context, the ACC system is expanded with a functionality but no other operating mode is used. This means that the ACC system is also active below the threshold speed on the condition that there is a vehicle traveling in front. The driver experiences a continuous system without a change of concept in the entire supported speed range, for example from 0 to 200 km/h. The driver does not need to acknowledge or trigger a changeover from one operating mode into another operating mode. A changeover of the operating mode cannot irritate the driver. Existing systems can be expanded by the method according to the invention so that there is also no changeover in the operating control and display functionality or in the warning concept. The threshold speed can either be predefined by the driver of the vehicle or set at the works. The threshold speed is also preferably set to 30 km/h. When the method is activated, a set speed which corresponds to the threshold speed or is above it is selected by the driver. The system can be activated above the threshold speed at any time, while above the threshold speed the longitudinal movement control is carried out according to the concept of free target selection. If the vehicle to be controlled has nothing in front of it, i.e. no vehicle traveling in front, said vehicle also being referred to as a guide vehicle, the speed of the driver's vehicle is adjusted to the set speed. When the method is activated, the vehicle therefore only travels more slowly than the threshold speed if a vehicle traveling in front travels at a speed below the threshold speed. At the same time, the longitudinal movement control below the threshold speed is carried out by adjusting the distance from the guide vehicle. At a vehicle speed below the threshold speed, the speed is not adjusted when there is no guide vehicle.

Below the threshold speed, the inter-vehicle distance control system can therefore be activated only if there is a guide vehicle. The explanation for this is that a large number of objects may be relevant at low speeds, inter alia also type 2 objects if there is no vehicle traveling in front. If these objects are also to be taken into account at low vehicle speeds below the threshold speed, the adjustment would have to be carried out according to the concept of free target selection. However, this is only possible at a vehicle speed above the threshold speed. For this reason, the invention assumes there is a guide vehicle for the vehicle control below the threshold speed so that only type 1 vehicles and vehicles traveling in front can be relevant as new objects when there are vehicles cutting in. The driver therefore as it were always experiences the concept of free target selection.

The control of the longitudinal movement below the threshold speed is advantageously only carried out according to the concept of tracking functionality. This means that the automatic longitudinal control is support only on a reliably tracked vehicle traveling in front, as an object which is detected as being relevant. Therefore, only a vehicle which is cutting in between the vehicle traveling in front and the vehicle to be controlled or a vehicle traveling in front of a vehicle which is cutting out are considered for a change of target. The tracked object does not need to be explicitly confirmed by the driver. The changeover from the concept of free target selection above the threshold speed to the concept of the tracking travel above the threshold speed, and vice versa, takes place automatically without the driver being aware of it.

An object detection means may be provided which filters out from sensor signals those objects which are significant for the “tracking travel” function. The detection logic comprises filtering of the data as a function of the travel speed and distance, verification of the measurement signals by multiple measurement, plausibility checking of the sensed objects and tracking of objects, in which detected objects are tracked over a certain period.

The driver of the vehicle is advantageously provided with a signal, in particular an audible and/or visual signal, if the longitudinal movement control system is not active and/or cannot be activated below the predefined speed. In this case, the longitudinal movement control system is switched off. This is indicated to the driver.

In one method variant it is possible to provide that after the vehicle is in a stationary state, the driver is requested to enable the automatic following of a vehicle traveling in front. This means that the vehicle does not drive off automatically after the stationary state. Automatic following of the guide vehicle does not take place until after acknowledgement (confirmation) by the driver, for example by pulling a cruise controller lever (activating memory) or by pressing the accelerator pedal. Alternatively, it is also conceivable for the driver to drive away manually and subsequently switch on the system. This means that the driver only has to switch on the method or the longitudinal movement control system but does not have to confirm a target.

A method variant in which the maximum deceleration capacity is increased as the vehicle's own speed drops is particularly preferred. This means that in particular if the driver is traveling at a short distance from the vehicle traveling in front in slow-moving traffic, rapid deceleration of the vehicle is made possible if the vehicle traveling in front slows down or stops. Rear-end collisions can be avoided by this measure. In particular it is possible to provide for the deceleration capacity to be changed gradually as a function of the instantaneous speed. Alternatively, a deceleration capacity of, for example, 4 m/s² below the predefined speed and of approximately 2 m/s² at relatively high speeds can be provided with a fluid transition.

The surroundings of the vehicle are advantageously sensed in the area in front, in particular sensed without gaps. This measure permits improved detection of vehicles cutting in, in particular at low speeds, owing to an additional sensor system for the short-range area. This measure permits in particular the vehicle to travel at low speeds and at a short distance.

In a further development of the method there is provision for three lanes to be sensed. This measure ensures that the longitudinal movement control system functions without difficulty also when traveling in a traffic jam or in slow-moving traffic on three-lane roads and vehicles cutting in can be sensed both from the left-hand lane and from the right-hand lane.

The invention also relates to a longitudinal movement control system of a vehicle, in particular an inter-vehicle distance control system, having a control unit for controlling the longitudinal movement of the vehicle and having a detection device for vehicles traveling in front, the system being active and/or being capable of being activated below a threshold value if a vehicle traveling in front is detected. Above the threshold speed, when the vehicle is traveling with no one in front, that is to say when there is no vehicle traveling in front, the speed of the vehicle is adjusted to a set speed. If there is a vehicle traveling in front which is slower than the set speed when the longitudinal movement control system switches on above the threshold speed, the distance from the vehicle traveling in front is adjusted. When the driver's vehicle approaches a relatively slow vehicle or when there is a vehicle cutting in in front of the vehicle to be controlled, the speed is reduced and the distance from the vehicle traveling in front is adjusted to a speed-dependent safety distance. If the vehicle traveling in front slows down to a speed below the threshold speed, the vehicle to be controlled is also slowed down because of the safety distance which is to be maintained. If the vehicle traveling in front turns off and therefore there is no guide vehicle, the longitudinal movement control system is deactivated until the vehicle has reached a speed above the threshold speed or a guide vehicle is detected again by the detection device and the system can be activated again by the driver.

In one embodiment of the invention, the detection device has sensors for sensing the short-range area in front of the vehicle without gaps. In order to sense without gaps the surroundings of the vehicle in the area in front in the direction of travel of the vehicle it is thus possible to detect not only the objects which have already been taken into account in ACC systems of the prior art, but also, at least in the short-range area (for example up to 30 meters), additional objects in the vehicle's lane and the two adjacent lanes and to describe their movement behavior. The relevant object for the control of the longitudinal movement is determined from this, for example by means of fusion of the sensor data.

In one preferred embodiment, a plurality of distributed beam sensors are provided. This permits three lanes to be sensed in the area in front of the vehicle. In particular it is possible to provide two 24 GHz radar short-range sensors and a 77 GHz radar long-range sensor and to mount them in the bumper. An image of the surroundings of the vehicle can be generated (merged) from the sensor data and the system can react thereto. High-resolution sensors with a large angle of aperture can alternatively be used and embodied, for example, as scanning infrared sensors with a scanning range of, for example, ≧40°. Furthermore, stereo image processing systems can be used.

Exemplary embodiments of the invention will be explained in more detail with reference to a drawing, in which:

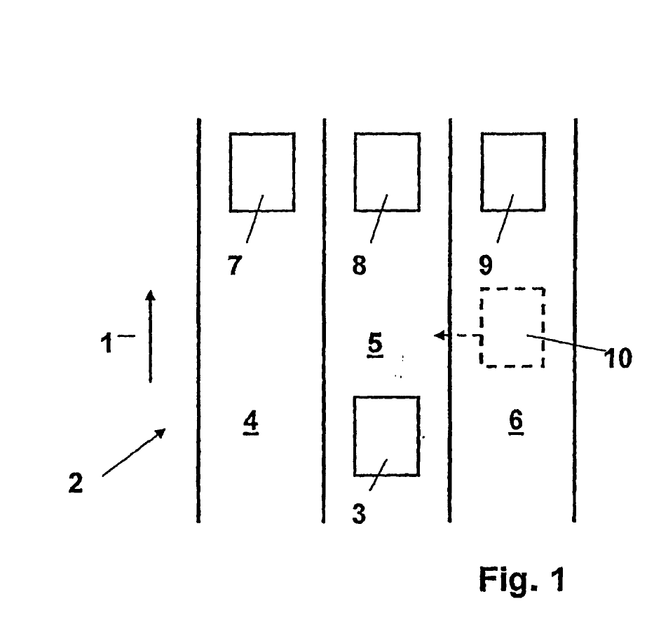

FIG. 1 is a schematic illustration of the invention.

FIG. 1 is a plan view of a three-lane road 2 in the direction of travel 1. In the area in front of the vehicle 3, for which a longitudinal movement control system is to be used, a vehicle 7-9 is located on each lane 4-6. In a speed range above a predefined threshold speed, the longitudinal movement control system operates according to the concept of free target selection. The system adjusts the distance from the vehicle 8 if the distance becomes less than a safety distance. If there is no guide vehicle 8, the speed of the vehicle 3 is adjusted to a set speed above the threshold speed. If there is no vehicle 8 traveling in front on the driver's own lane 5 when the longitudinal movement control system is activated, the speed is adjusted to the set speed until a vehicle 8 appears in the capture range of the sensors of the vehicle 3 or a vehicle changes onto the driver's own lane 3 and is sensed. Then, an inter-vehicle distance control process takes place. If there is a vehicle 8 traveling in front when the longitudinal movement control system is activated above the set speed, the distance is immediately adjusted. In the concept of free target selection, type 1 objects, like the object 10 and the vehicles 7, 9 if they change onto the lane 5, and type 2 objects (vehicle 8) are taken into account.

In a speed range below the threshold speed, the longitudinal movement control system is active only if a vehicle 8 traveling in front is detected. The longitudinal movement control system then operates according to the concept of the tracking travel and takes into account type 1 objects such as the vehicle 10, and vehicles 8 traveling in front of the vehicle on the driver's own lane if the vehicle 8 cuts out. The vehicle 10 is located in the short-range area of the vehicle 3 and is sensed on the adjacent lane 6. At first, the longitudinal movement control system orientates itself according to the vehicle 8 traveling in front at a short distance. As soon as the vehicle 10 moves into the lane 5, a different guide vehicle is available so that orientation is carried out with the vehicle 10. The longitudinal movement control system observes the vehicle 10 so that it can react quickly to the vehicle 10 cutting in and can trigger deceleration of the vehicle 3. The driver does not notice the change of concept between free target selection and tracking travel at all since the operating control concept is configured in a uniform way. If there is no vehicle 8 traveling in front, the longitudinal movement control system cannot be activated below the threshold speed.

1. A method for controlling the longitudinal movement of a vehicle (3), in particular by means of a longitudinal movement control system, wherein, for vehicle speeds above a threshold speed, the vehicle speed is adjusted to a higher selected set speed if no vehicle (8) traveling in front is detected, and if a vehicle (8) traveling in front is detected the distance from this vehicle (8) traveling in front is adjusted, characterized in that, below the threshold speed, the longitudinal movement of the vehicle (3) is controlled only if a vehicle (8) traveling in front is detected, the control below the threshold speed being carried out by adjusting the distance from the vehicle (8) traveling in front.

2. The method as claimed in claim 1, characterized in that a uniform operating control concept is used for controlling the longitudinal movement over the entire speed range.

3. The method as claimed in claim 1, characterized in that the control of the longitudinal movement below the threshold speed is carried out according to the concept of tracking functionality.

4. The method as claimed in claim 1, characterized in that the driver of the vehicle is provided with a signal, in particular an audible and/or visual signal, if the longitudinal movement control system is not active and/or cannot be activated below the threshold speed.

5. The method as claimed in claim 1, characterized in that after the vehicle (3) is in a stationary state, the driver is requested to enable automatic following of a guide vehicle (8).

6. The method as claimed in claim 1, characterized in that the maximum deceleration capacity is increased as the vehicle's own speed drops.

7. The method as claimed in claim 1, characterized in that the surroundings of the vehicle (3) are sensed in the area in front, in particular sensed without gaps.

8. The method as claimed in claim 8, characterized in that three lanes (4-6) are sensed.

9. A longitudinal movement control system of a vehicle (3), in particular for carrying out the method as claimed in one of the preceding claims, having a control unit for controlling the longitudinal movement of the vehicle (3) and having a detection device for vehicles (8) traveling in front, characterized in that the system is active and/or can be activated below a threshold speed only if a vehicle (8) traveling in front is detected, the control when the system is active below the threshold speed being carried out by adjusting the distance from the vehicle (8) traveling in front.

10. The system as claimed in claim 9, characterized in that the detection device comprises sensors for sensing the short-range area in front of the vehicle (3) without gaps.

11. The system as claimed in claim 10, characterized in that a plurality of distributed beam sensors are provided.
